(19) United States
(12) Patent Application Publication
(10) Pub. No.: US 2026/0274218 A1
(43) Pub. Date: Sep. 17, 2026

(54) DRIVING ASSISTANCE DEVICE AND DRIVING ASSISTANCE METHOD

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Kento OISHI, Toyko (JP); Shimpei HIGASHINO, Atsugi-shi (JP)

(21) Appl. No.: 19/562,028

(22) Filed: Mar. 10, 2026

(30) Foreign Application Priority Data
Mar. 11, 2025 (JP) 2025-038289

(51) Int. Cl. B60T 7/22

(52) U.S. Cl. CPC B60T 7/22; B60T 2210/32; B60T 2250/04

(57) ABSTRACT

A driving assistance device for a mobile object, the mobile object including a first sensor that detects a target present in the surroundings of the mobile object, the driving assistance device includes: a collision prediction unit configured to predict presence or absence of a collision between the target and the mobile object; and a braking instruction unit configured to cause a braking force to act on the mobile object in response to the collision between the target and the mobile object being predicted; and cause the braking force to continuously act on the mobile object until a position of the target becomes at a rear of the mobile object in response to the target detected becoming undetectable by the first sensor in a predetermined region near the first sensor.

### CROSS-REFERENCE TO RELATED APPLICATION

This application is based on and claims the benefit of priority from Japanese Patent Application No. 2025-38289, the disclosure of which is incorporated in its entirety herein by reference.

### BACKGROUND

### Technical Field

The present disclosure relates to a driving assistance device and a driving assistance method.

### Background Art

Technologies for suppressing a collision between a host vehicle and a surrounding target such as another vehicle have been variously proposed. For example, a technology to cause braking to continue when a target has become undetectable because a distance between a sensor mounted on a vehicle and the target becomes close is disclosed. In this technology, braking is continued for a collision prediction time between the target and the vehicle from a point of time when the target has become undetectable. The braking is released after the collision prediction time has elapsed.

### SUMMARY

In the present disclosure, provided is a driving assistance device as follows.

The driving assistance device for a mobile object, the mobile object including a first sensor that detects a target present in the surroundings of the mobile object, the driving assistance device includes at least one of (i) a circuit and (ii) a processor with a memory storing computer program code executable by the processor, the at least one of the circuit and the processor configured to cause the driving assistance device to: predict presence or absence of a collision between the target and the mobile object; cause a braking force to act on the mobile object in response to the collision between the target and the mobile object being predicted; and cause the braking force to continuously act on the mobile object until a position of the target becomes at a rear of the mobile object in response to the target detected becoming undetectable by the first sensor in a predetermined region near the first sensor.

In the present disclosure, also provided is a driving assistance method as follows.

The driving assistance method for a mobile object, the mobile object including a first sensor that detects a target present in surroundings of the mobile object, the driving assistance method includes: predicting presence or absence of a collision between the target and the mobile object; causing a braking force to act on the mobile object in response to the collision between the target and the mobile object being predicted; and causing the braking force to continuously act on the mobile object until a position of the target becomes at a rear of the mobile object in response to the target detected becoming undetectable by the first sensor in a predetermined region near the first sensor.

### BRIEF DESCRIPTION OF THE DRAWINGS

FIG. 1 is a block diagram showing a schematic configuration of a driving assistance device in an embodiment of the present disclosure;

FIG. 2 is a view for explaining a function of a determination unit; and

FIG. 3 is a flowchart showing a procedure of braking processing after collision prediction.

### DETAILED DESCRIPTION OF THE PREFERRED EMBODIMENTS

### [PTL 1] JP 2009-51241 A

In the technology of PTL 1, the collision prediction time is calculated using a relative distance and a relative speed between the host vehicle and the target at a point of time when the target has become undetectable. However, the relative distance and the relative speed can change after the target has become undetectable. Therefore, a discrepancy between the collision prediction time and a time to an actual collision occurs in some cases. This causes the braking to be released in spite of actual necessity to continue braking, and the host vehicle and the target are in danger of colliding. There is room for improvement regarding braking when a target has become undetectable by a sensor. Note that such a problem is for not only a vehicle but also an optional mobile object.

The present disclosure can be realized as the following aspects.

According to an aspect of the present disclosure, there is provided a driving assistance device (100) for a mobile object, the mobile object including a first sensor (11) that detects a target present in the surroundings of the mobile object, the driving assistance device includes: a collision prediction unit (110) configured to predict presence or absence of a collision between the target and the mobile object; and a braking instruction unit (140) configured to cause a braking force to act on the mobile object in response to the collision between the target and the mobile object being predicted; and cause the braking force to continuously act on the mobile object until a position of the target becomes at a rear of the mobile object in response to the target detected becoming undetectable by the first sensor in a predetermined region near the first sensor.

According to the driving assistance device of this aspect, the braking instruction unit is configured to cause the braking force of the mobile object to continuously act until the position of the target becomes at the rear of the mobile object in response to the target detected becoming undetectable by the first sensor in a predetermined region near the first sensor, so that the braking force can be continued acting over a longer time compared with a configuration that causes the braking force to act for the collision prediction time at a time of point when the target has become undetectable. This can further suppress a collision between the target and the mobile object compared with a configuration that causes the braking force to act for the collision prediction time, even when the motion of the target has changed from a point of time when the target has become undetectable.

### A. Embodiment

### Outline of Driving Assistance Device 1

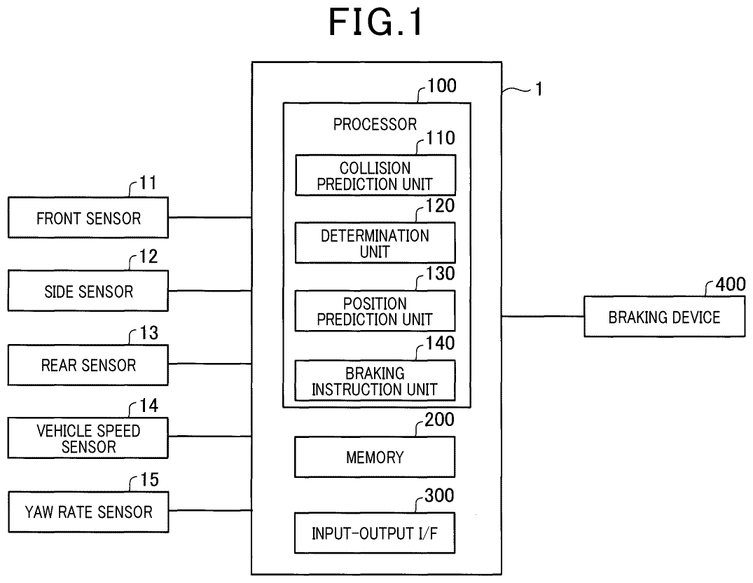

A driving assistance device 1 shown in FIG. 1 is used mounted on a vehicle. The driving assistance device 1 uses a detection result of a sensor mounted on the vehicle to predict presence or absence of a collision with a target existing around the vehicle, and provides braking force to the vehicle in response to a collision being predicted. Further, the driving assistance device 1 continues or releases the braking force corresponding to a place where the target has disappeared, when the target with which a collision is predicted has become undetectable by a sensor. Braking force is provided by actuation of a later-described braking device 400. Note that hereinafter, the vehicle on which the driving assistance device 1 is mounted will be also called a host vehicle.

The “target” in the present disclosure is a detection object of a sensor mounted on the vehicle. Examples of the target include a pedestrian, a bicycle, an animal, a vehicle other than the host vehicle, a building, a telegraph pole, and a tree.

### Configuration of Sensor

As shown in FIG. 1, signals are transmitted to the driving assistance device 1 from a plurality of sensors via an input-output interface (I/F) 300. The plurality of sensors shown in FIG. 1 is mounted on the vehicle on which the driving assistance device 1 is mounted. The plurality of sensors include a front sensor 11, a side sensor 12, a rear sensor 13, a vehicle speed sensor 14, and a yaw rate sensor 15.

The front sensor 11 detects a target existing in a region containing the front of a host vehicle. The side sensor 12 detects a target existing in a region containing the side of a host vehicle. The rear sensor 13 detects a target existing in a region containing the rear of a host vehicle. Note that the “side of a host vehicle” includes the front side and the rear side of a host vehicle. The front side and the rear side indicate, for example, a range of 30 degrees to 60 degrees from an axis along the longitudinal direction (advancing/reversing direction) of a host vehicle extending through the lateral center of a host vehicle. An example of the front sensor 11 and the side sensor 12 is a distance measuring device. Examples of the distance measuring device include a millimeter-wave radar and a device to which light detection and ranging (LiDAR) is applied. A distance measuring device emits electromagnetic waves toward a target and detects a distance to the target utilizing a time difference between the emitting timing and the receiving timing of the reflected waves. Therefore, the distance may not be detectable when a distance between the distance measuring device and the target approaches a short distance. Such a distance is, for example, 50 cm to 2 m or less. Further, when the front of a vehicle sinks due to operation of the later-described braking device 400, the distance for the target positioned at a short distance also may not be detectable because the measuring device cannot receive reflected waves.

The front sensor 11 is disposed to, for example, the center part of a front bumper of a host vehicle. The side sensor 12 is disposed to, for example, the left end part and the right end part of a front bumper of a host vehicle. The rear sensor 13 is disposed to, for example, the center part of a rear bumper of a host vehicle. The detection region of the front sensor 11 and the detection region of the side sensor 12 partly overlap with each other. Further, the detection region of the rear sensor 13 and the detection region of the side sensor 12 partly overlap with each other. Note that the front sensor 11 is an example of the “first sensor” of the present disclosure. Hereinafter, the front sensor 11, the side sensor 12, and the rear sensor 13 may be collectively called the “sensor”.

The vehicle speed sensor 14 generates a signal corresponding to the travelling speed of a host vehicle. The vehicle speed sensor 14 detects, for example, the rotational speed of a tire of a host vehicle. A signal emitted by the vehicle speed sensor 14 is used for the operation of the travelling speed and acceleration of a host vehicle by the driving assistance device 1.

The yaw rate sensor 15 generates a signal corresponding to a yaw rate acting on a host vehicle. A signal emitted by the yaw rate sensor 15 is used to calculate the yaw rate of a host vehicle by the driving assistance device 1.

### Configuration of Braking Device 400

The braking device 400 provides, to a host vehicle, braking force for braking the host vehicle. The braking device 400 provides the braking force under instruction by an occupant of the host vehicle or instruction by the driving assistance device 1. Instruction by the occupant is performed using an input device such as a brake pedal. Instruction by the driving assistance device 1 is performed through transmission of a control signal.

### Configuration of Driving Assistance Device 1

The driving assistance device 1 includes a processor 100, a memory 200, and an input-output I/F 300. Note that the driving assistance device 1 may be configured as a part of an electronic control unit (ECU) that executes various controls of the host vehicle.

The driving assistance device 1 is not limited to the above configuration and may be constituted by hardware circuits such as dedicated circuits, logic circuits, ASICs, FPGAs, or the like.

The processor 100 executes a program stored in the memory 200 thereby to function as a collision prediction unit 110, a determination unit 120, a position prediction unit 130, and a braking instruction unit 140.

### Function of Collision Prediction Unit 110

The collision prediction unit 110 predicts presence or absence of a collision between a target detected by the sensor and the host vehicle. In the present embodiment, the collision prediction unit 110 predicts presence or absence of a collision with a target detected by the front sensor 11. That is, it can be said that the target is positioned at the front of the host vehicle. Further, the collision prediction unit 110 in the present embodiment predicts presence or absence of a collision using a relative distance between the host vehicle and the target and a relative speed between the host vehicle and the target. The relative distance is calculated using a detection result of the sensor. The relative speed is calculated using a detection result of the sensor and a speed of the host vehicle. The speed of the host vehicle is calculated using a signal transmitted from the vehicle speed sensor 14. The collision prediction unit 110 transmits a signal to a later-described braking instruction unit 140 in response to a collision between the host vehicle and the target being predicted.

### Function of Determination Unit 120

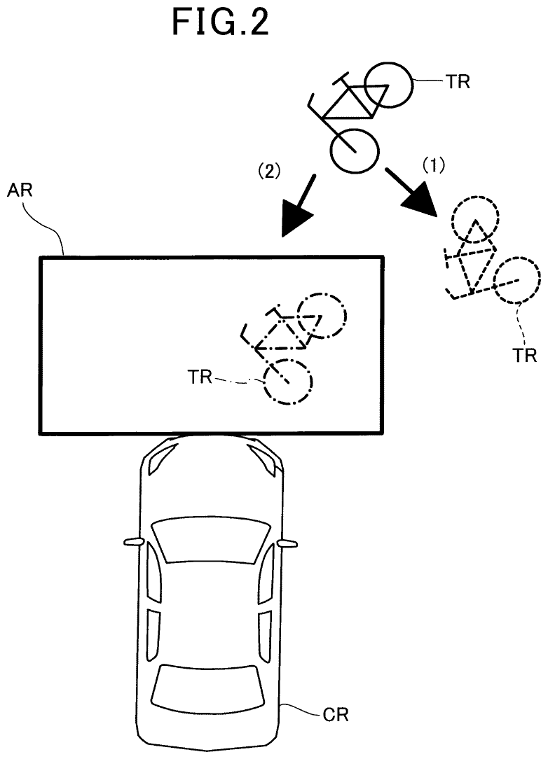

The determination unit 120 determines whether the target which is predicted to collide with the host vehicle is continuously detected by the front sensor 11. Further, the determination unit 120 determines whether a position in which the target has become undetectable is within a predetermined region AR when the target which is predicted to collide with the host vehicle has become undetectable by the front sensor 11. Note that the “position in which the target has become undetectable” indicates the last position of the target detected by the front sensor 11. Information regarding the region AR is previously stored in the memory 200. The determination unit 120 determines whether the position in which the target has become undetectable is within the region AR using a detection result by the sensor and information regarding the region AR stored in the memory 200. The function of the determination unit 120 will be described using FIG. 2.

As shown in FIG. 2, the predetermined region AR in the present embodiment is set at the front of a host vehicle CR. Specifically, the region AR is previously set as a region near the front sensor 11 where detection of a target by the front sensor 11 is difficult. For example, the region AR may have a rectangular shape when viewed from above. The width of the region AR is, for example, wider than the width of the host vehicle CR. The width of the region AR is, for example, 2 m. The length of the region AR is, for example, 50 cm to 2 m. The height of the region AR is, for example, 1 m from the ground. Note that the width, length, and height of the region AR are not limited thereto and may be optional values. Further, the shape of the region AR may be optional. The shape of the region AR may be, for example, fan-like when viewed from above.

In FIG. 2, an example in which a collision between a bicycle TR as a target and the host vehicle CR is predicted is described. The bicycle TR heading from the front of the host vehicle CR toward the host vehicle CR is detected by the front sensor 11. Such a bicycle TR becomes undetectable by the front sensor 11 in some cases. There are two factors for the bicycle TR becoming undetectable.

The first factor is that as shown by (1) in FIG. 2, the bicycle TR moves outside the maximum detection range of the front sensor 11. In FIG. 2, the bicycle TR after having moved is shown with broken lines. In such a case, the determination unit 120 determines that the bicycle TR as a target has become undetectable by the front sensor 11 and that a position in which the target has become undetectable is outside the predetermined region AR.

The second factor is that as shown by (2) in FIG. 2, the bicycle TR is positioned in a region near the front sensor 11, i.e., within the predetermined region AR and has become difficult to detect by the front sensor 11. In FIG. 2, the bicycle TR in the region AR is shown with dot-dashed lines. In such a case, the determination unit 120 determines that the bicycle TR as a target has become undetectable by the front sensor 11 and that a position in which the bicycle TR has become undetectable is within the predetermined region AR.

When none of the above-described (1) and (2) applies, the determination unit 120 determines that the bicycle TR as a target is continuously detected by the front sensor 11.

### Function of Position Prediction Unit 130

The position prediction unit 130 shown in FIG. 1 predicts the position of a target in response to the target becoming undetectable by the front sensor 11. The position prediction unit 130 in the present embodiment predicts the position of the target using the position and speed of the target immediately before the target has become undetectable and the speed and acceleration of the host vehicle CR. The position and speed of the target are detected by the sensor, and the speed and acceleration of the host vehicle CR are calculated by a signal emitted by the vehicle speed sensor 14.

### Function of Braking Instruction Unit 140

The braking instruction unit 140 causes braking force to act on the host vehicle CR when it is predicted by the collision prediction unit 110 that the target and the host vehicle CR will collide. The action of braking force is realized by a control signal to cause braking force to act on the host vehicle CR transmitted from the braking instruction unit 140 to the braking device 400. This suppresses a collision between the target and the host vehicle CR.

Further, the braking instruction unit 140 in the present disclosure causes the braking force of the host vehicle CR to continuously act until the position of the target becomes at the rear of the host vehicle CR, when it is predicted by the collision prediction unit 110 that the target and the host vehicle CR will collide and it is determined by the determination unit 120 that a position in which the target has become undetectable is within the predetermined region AR. In the present embodiment, the position of the target is predicted by the position prediction unit 130. This allows braking force to continuously act until a point of time when the target is highly possibly positioned at the rear of the host vehicle CR.

Further, the braking instruction unit 140 releases the braking force of the host vehicle CR when it is determined by the determination unit 120 that a position in which the target has become undetectable is outside the predetermined region AR. When a position in which the target has become undetectable is outside the region AR, the target has highly possibly moved outside the maximum detection range of the front sensor 11, and the target and the host vehicle CR are unlikely to collide. When braking force is continuously provided in such a situation, a vehicle following the host vehicle CR is in danger of colliding with the host vehicle CR. Therefore, a collision between the following vehicle and the host vehicle CR can be suppressed by releasing braking force.

### Braking Processing After Collision Prediction

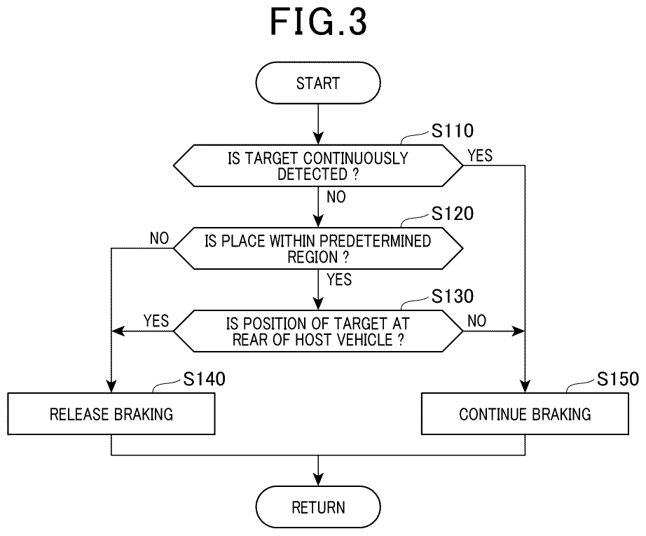

The braking processing after collision prediction shown in FIG. 3 is repeatedly executed in response to a collision between the target detected by the front sensor 11 and the host vehicle CR being predicted. Note that before the braking processing, a control signal to cause braking force to act on the host vehicle CR has been transmitted from the braking instruction unit 140 to the braking device 400.

The determination unit 120 determines whether the target is continuously detected by the front sensor 11 (S110). When the target is continuously detected by the front sensor 11 (S110: YES), braking is continued (S150). Specifically, the braking instruction unit 140 transmits a control signal to the host vehicle CR for continuing the already acting braking force.

In response to determining that the target is not detected by the front sensor 11 (S110: NO), the determination unit 120 determines whether a place in which the target has become undetectable is within the predetermined region AR near the front sensor 11 (S120). In response to determining that a place in which the target has become undetectable is not within the region AR (S120: NO), braking is released (S140). Specifically, the braking instruction unit 140 transmits a control signal to the host vehicle CR to release the already acting braking force.

In response to determining that a place in which the target has become undetectable is within the predetermined region AR (S120: YES), the braking instruction unit 140 determines whether the position of the target is at the rear of the host vehicle CR (S130). The position of the target is predicted by the position prediction unit 130 and transmitted. In response to determining that the position of the target is at the rear of the host vehicle CR (S130: YES), braking is released (S140). In response to determining that the position of the target is not at the rear of the host vehicle CR (S130: NO), braking is continued (S150).

According to the driving assistance device 1 of the above-described embodiment, the braking instruction unit 140 causes the braking force of the host vehicle CR to continuously act until the position of the target becomes at the rear of the host vehicle CR in response to the target detected becoming undetectable by the front sensor 11 in the predetermined region AR near the front sensor 11, so that it is possible to cause braking force to continuously act over a longer time compared with a configuration that causes braking force to act for a collision prediction time at a point of time when the target has become undetectable. This can further suppress a collision between the target and the host vehicle CR compared with a configuration that causes braking force to act for the collision prediction time, even when the motion of the target has changed from a point of time when the target has become undetectable.

Further, according to the driving assistance device 1 of the embodiment, the braking instruction unit 140 releases the braking of the host vehicle CR in response to the target detected becoming undetectable by the front sensor 11 outside the region AR, so that a collision between the host vehicle CR and a vehicle following the host vehicle CR can be suppressed compared with a configuration that causes braking to uniformly continue in response to the target becoming undetectable. Specifically, when a place in which the target has become undetectable is outside the region AR, collision provability between the target and the host vehicle CR is relatively small. In such a case, releasing braking can suppress unnecessary speed reduction of the host vehicle CR and can suppress a collision between the host vehicle CR and the following vehicle.

Further, according to the driving assistance device 1 of the embodiment, the position prediction unit 130 predicts the position of the target in response to the target becoming undetectable by the front sensor 11, and the braking instruction unit 140 causes the braking force of the host vehicle CR to continuously act until the predicted position of the target becomes at the rear of the host vehicle CR, so that the position of the target can be predicted even when the position of the target cannot be determined using a sensor other than the front sensor 11.

Further, according to the driving assistance device 1 of the embodiment, the position prediction unit 130 predicts the position of the target using the position and speed of the target immediately before the target has become undetectable and the speed and acceleration of the host vehicle CR, so that the position of the target can be predicted by a relatively simple method.

### B. Other Embodiments

(B1) In the above-described embodiment, the braking instruction unit 140 causes the braking force of the host vehicle CR to continuously act until the position of the target predicted by the position prediction unit 130 becomes at the rear of the host vehicle CR. However, the present disclosure is not limited thereto. The braking instruction unit 140 may cause the braking force of the host vehicle CR to continuously act until the position of the target detected by another sensor different from the front sensor 11 becomes at the rear of the host vehicle CR. That is, although the position of the target is predicted in the embodiment, the position of the target may be actually detected by another sensor in another embodiment. Note that this other sensor is an example of the “second sensor” in the present disclosure. Another sensor may be, for example, the side sensor 12 or the rear sensor 13 shown in FIG. 1. According to such an aspect, the braking instruction unit 140 causes the braking force to continuously act using the position of the target actually detected by another sensor, so that the braking force can be continuously provided over a more precise time compared with a configuration that predicts the position of the target. This can further suppress a collision between the target and the host vehicle CR.
(B2) In the above-described embodiment, the collision prediction unit 110 predicts presence or absence of a collision using the relative distance between the host vehicle CR and the target and the relative speed between the host vehicle CR and the target. However, the present disclosure is not limited thereto. The collision prediction unit 110 may predict presence or absence of the collision by an optional method. For example, the collision prediction unit 110 may predict the movement trajectory of the host vehicle CR and the movement trajectory of the target, and predict that the host vehicle CR and the target will collide when the two movement trajectories intersect. The movement trajectory of the host vehicle CR is predicted using the travelling speed of the host vehicle CR and the yaw rate. The travelling speed of the host vehicle CR is calculated using a signal transmitted from the vehicle speed sensor 14 shown in FIG. 1. The yaw rate is calculated using a signal transmitted from the yaw rate sensor 15. The movement trajectory of the target is calculated using a time-series positional change of the target detected by the sensor. Similarly, the position prediction unit 130 may predict the position of the target by an optional method.
(B3) In the above-described embodiment, the target is detected by the front sensor 11. However, the present disclosure is not limited thereto. The target may be detected by the side sensor 12. That is, the side sensor 12 may be used as the “first sensor” of the present disclosure.
(B4) In the above-described embodiment, the driving assistance device 1 is mounted on a vehicle. However, the present disclosure is not limited thereto. The driving assistance device 1 may be mounted on an optional mobile object. The mobile object is, for example, a ship, an airplane, or a so-called flying car.
(B5) The driving assistance device 1 and the method therefor according to the present disclosure may be realized by a dedicated computer provided by configuring a memory and a processor programmed to execute one or more functions embodied by a computer program. Alternatively, the driving assistance device 1 and the method therefor according to the present disclosure may be realized by a dedicated computer provided by configuring a processor with one or more dedicated hardware logic circuits. Alternatively, the driving assistance device 1 and the method therefor according to the present disclosure may be realized by one or more dedicated computers configured by a combination of the memory and the processor programmed to execute one or more functions and the processer configured with one or more hardware logic circuits. The computer program may be stored as an instruction to be executed by a computer, in a computer-readable non-transitory tangible memory medium.

The present disclosure is not limited to the above-described embodiments, and can be realized in various configurations within the scope that does not depart from the spirit thereof. For example, technical features in the embodiments corresponding to respective technical features in the aspects described in Summary of the Invention can be appropriately replaced or combined in order to solve a part or the entirety of the above-described problems or in order to achieve a part or the entirety of the above-described effects. Further, the technical features can be appropriately deleted if not described as essential herein. The present disclosure can be realized in aspects such as a method of collision prediction, a computer program for realizing such a method, and a non-temporary memory medium storing such a computer program.

The present disclosure may be realized by, for example, the following aspects.

### Aspect 1

A driving assistance device (1) for a mobile object, the mobile object including a first sensor (11) that detects a target present in the surroundings of the mobile object, the driving assistance device includes:
at least one of (i) a circuit and (ii) a processor with a memory storing computer program code executable by the processor, the at least one of the circuit and the processor configured to cause the driving assistance device to:
predict presence or absence of a collision between the target and the mobile object;
cause a braking force to act on the mobile object in response to the collision between the target and the mobile object being predicted; and
cause the braking force to continuously act on the mobile object until a position of the target becomes at a rear of the mobile object in response to the target detected becoming undetectable by the first sensor in a predetermined region near the first sensor.

### Aspect 2

The driving assistance device according to aspect 1, in which
the at least one of the circuit and the processor is further configured to cause the driving assistance device to:
predict a position of the target in response to the target becoming undetectable by the first sensor, and
cause the braking force to continuously act on the mobile object until the predicted position of the target becomes at the rear of the mobile object.

### Aspect 3

The driving assistance device according to aspect 2, in which
the at least one of the circuit and the processor is further configured to cause the driving assistance device to predict the position of the target using a position and speed of the target immediately before the target has become undetectable and a speed and acceleration of the mobile object.

### Aspect 4

The driving assistance device according to aspect 1, in which
the mobile object further includes a second sensor (13) that detects the target present in the surroundings of the mobile object, the second sensor being different from the first sensor, and
the at least one of the circuit and the processor is further configured to cause the driving assistance device to cause the braking force to continuously act on the mobile object until a position of the target detected by the second sensor becomes at the rear of the mobile object.

### Aspect 5

A driving assistance device (1) for a mobile object, the mobile object including a first sensor (11) that detects a target present in the surroundings of the mobile object, the driving assistance device includes:
a collision prediction unit (110) configured to predict presence or absence of a collision between the target and the mobile object; and
a braking instruction unit (140) configured to
cause a braking force to act on the mobile object in response to the collision between the target and the mobile object being predicted; and
cause the braking force to continuously act on the mobile object until a position of the target becomes at a rear of the mobile object in response to the target detected becoming undetectable by the first sensor in a predetermined region near the first sensor.

### Aspect 6

A driving assistance method for a mobile object, the mobile object including a first sensor that detects a target present in surroundings of the mobile object, the driving assistance method includes:
predicting presence or absence of a collision between the target and the mobile object;
causing a braking force to act on the mobile object in response to the collision between the target and the mobile object being predicted; and
causing the braking force to continuously act on the mobile object until a position of the target becomes at a rear of the mobile object in response to the target detected becoming undetectable by the first sensor in a predetermined region near the first sensor.

What is claimed is:

1. A driving assistance device for a mobile object, the mobile object including a first sensor that detects a target present in the surroundings of the mobile object, the driving assistance device comprising:
at least one of (i) a circuit and (ii) a processor with a memory storing computer program code executable by the processor, the at least one of the circuit and the processor configured to cause the driving assistance device to:
predict presence or absence of a collision between the target and the mobile object;
cause a braking force to act on the mobile object in response to the collision between the target and the mobile object being predicted; and
cause the braking force to continuously act on the mobile object until a position of the target becomes at a rear of the mobile object in response to the target detected becoming undetectable by the first sensor in a predetermined region near the first sensor.

2. The driving assistance device according to claim 1, wherein
the at least one of the circuit and the processor is further configured to cause the driving assistance device to:
predict a position of the target in response to the target becoming undetectable by the first sensor, and
cause the braking force to continuously act on the mobile object until the predicted position of the target becomes at the rear of the mobile object.

3. The driving assistance device according to claim 2, wherein
the at least one of the circuit and the processor is further configured to cause the driving assistance device to predict the position of the target using a position and speed of the target immediately before the target has become undetectable and a speed and acceleration of the mobile object.

4. The driving assistance device according to claim 1, wherein
the mobile object further includes a second sensor that detects the target present in the surroundings of the mobile object, the second sensor being different from the first sensor, and
the at least one of the circuit and the processor is further configured to cause the driving assistance device to cause the braking force to continuously act on the mobile object until a position of the target detected by the second sensor becomes at the rear of the mobile object.

5. A driving assistance device for a mobile object, the mobile object including a first sensor that detects a target present in the surroundings of the mobile object, the driving assistance device comprising:
a collision prediction unit configured to predict presence or absence of a collision between the target and the mobile object; and
a braking instruction unit configured to
cause a braking force to act on the mobile object in response to the collision between the target and the mobile object being predicted; and
cause the braking force to continuously act on the mobile object until a position of the target becomes at a rear of the mobile object in response to the target detected becoming undetectable by the first sensor in a predetermined region near the first sensor.

6. A driving assistance method for a mobile object, the mobile object including a first sensor that detects a target present in surroundings of the mobile object, the driving assistance method comprising:
predicting presence or absence of a collision between the target and the mobile object;
causing a braking force to act on the mobile object in response to the collision between the target and the mobile object being predicted; and
causing the braking force to continuously act on the mobile object until a position of the target becomes at a rear of the mobile object in response to the target detected becoming undetectable by the first sensor in a predetermined region near the first sensor.
